(19) United States
(12) Patent Application Publication
(10) Pub. No.: US 2003/0144457 A1
(43) Pub. Date: Jul. 31, 2003

(54) Hyperbranched esteroxazoline polymers

(76) Inventor: Richard Hendrikus Gerrit Brinkhuis, Zwolle (NL)

Correspondence Address: Michelle Burke, Akzo Nobel Inc., Intellectual Property Dept., 7 Livingstone Avenue, Dobbs Ferry, NY, 10522, US

(21) Appl. No.: 10/322,403

(22) Filed: Dec. 17, 2002

Related U.S. Application Data
(60) Provisional application No. 60/360,309, filed on Feb. 28, 2002.

(30) Foreign Application Priority Data
Dec. 21, 2001 (EP) EP 01205155.3

(51) Int. Cl. C08G 63/02

(52) U.S. Cl. 528/272

(57) ABSTRACT

The invention pertains to a hyperbranched esteroxazoline polymer obtainable from a polymerization reaction of A-functional and B-functional compounds, characterized in that the polymer comprises a polymer backbone having ester and oxazoline groups and having hydroxymethyl end groups, wherein the A-functional compound stands for tris(hydroxymethyl)methanamine and the B-functional compound stands for a cyclic anhydride, or a dicarboxylic acid, or a derivative thereof; having a ratio of equivalents of oxazoline groups to equivalents of backbone ester groups of 1:2 to 2:1, and a number average degree of polymerization Pn greater than 6.

This application claims priority of European Patent Application No. 01205155.3, filed Dec. 21, 2001, and U.S. Provisional Patent Application No. 60/360,309, filed Feb. 28, 2002.

### FIELD OF THE INVENTION

The invention pertains to a hyperbranched esteroxazoline polymer, a process for the preparation thereof, to emulsions and dispersions comprising said esteroxazoline polymer, to binder compositions comprising the same, and to the use of said binder compositions in coating, ink, and adhesive compositions.

### BACKGROUND OF THE INVENTION

Hyperbranched resins based on various types of chemistry have been disclosed in many patents over the last decade. Hyperbranched resins based on DMPA (dimethylolpropionic acid) have entered the market under the name of Boltorn® (ex Perstorp), and DSM has disclosed a new class of hyperbranched polyesteramides in WO 99/16810, which was launched under the name of Hybrane®.

The term “hyperbranched polymer” refers to a strongly branched polymer, without the perfection of a dendrimer, which in general requires a step-by-step alternating chemistry to be prepared. The term hyperbranched resins is used for materials made in a one-pot procedure without a strict generation-by-generation approach, which is strongly preferred from a process technological as well as an economical point of view. Such procedure, however, is at the expense of the degree of branching (which typically would be around 0.5 for the Boltorn® resins vs. 1.0 for perfect dendrimers, using the Frechet definition of branching (J. Am. Chem. Soc., 113, 4583 (1991)) and also at the expense of the monodispersity which is typical for a perfect dendrimer. It is claimed that many of the typical dendrimer characteristics are still found in these less-than-perfect hyperbranched molecules.

The advantages of dendrimers and hyperbranched resins in terms of e.g. coating applications are the low hydrodynamic volume and the compactness of the macromolecules, leading to lower viscosities than for linear polymers of similar molecular weight (and thus to environmental advantages in terms of the amount of solvent needed in application), the high functionality on the “exterior” of the macromolecules (rapid drying, high cross-link density), and the possibility of using modifications of these architectures to create a more or less core-shell type of macromolecular structure, with a core nanophase of contrasting properties hidden within the modified shell, with potential benefits in compatibility and mechanical properties.

Both the DMPA-polyesters and the Hybrane®-type polyesteramides are based on the concept of a condensation of an A₂B-type monomer, which is known to lead to higher degrees of branching and narrower molar mass distributions (MMD) than in a corresponding conventional A₃+B₂ condensation, as was disclosed about a fifty years ago by Flory (J. Am. Chem. Soc., 74, 2718 (1952)). This means that with an A₂B monomer condensation higher Mn values can be obtained without running into gelation problems than with an A₃+B₂ monomer condensation.

The Boltorn® DMPA-hyperbranched polymers were claimed to be useful for many applications, and their hyperbranched architecture has been well studied. A drawback of these materials is the fact that the hyperbranched DMPA-polyester core is quite soft and non-polar (not counting the effect of the terminating hydroxy groups). There are no straightforward ways to broadly vary the physical properties of this hyperbranched core.

The Hybrane®-type materials are claimed to utilize the A₂B concept by preparing an A₂B intermediate in situ through a selective reaction of a secondary amine functionality on di-isopropanol amine (an A₂a molecule, wherein a represents the amine and A the hydroxy) with an anhydride Bb (wherein the original anhydride functionality is called b and the resulting carboxylic acid is denoted as B). In comparison with the DMPA resins, they are much more flexible with regard to tuning of their physical properties, since many different types of anhydrides can be used to obtain the required hardness and polarity characteristics. On the other hand, the degree of branching of the DMPA-polyesters and the rather narrow polydispersity of the Boltorn®-type polymers cannot be matched by the Hybrane®-type materials, due to a side reaction which can occur and will lead to etherification and/or imination (effectively an AA or Aa condensation), and due to an imperfect selectivity of the above-mentioned first step, together with the fact that the selectivity of the first step can be overruled by a randomizing effect of trans-esterification and trans-amidation reactions, as a result of the highly dynamical nature of the polymerization of these resins, as was disclosed by DSM (Van Benthem et al, Macromolecules, 34, 3552, 3559, (2001); Proceedings of the XXVth International Conference on Organic Coatings, Athens, 1999, p. 345). This architectural imperfection with respect to a “real” A₂B system as DMPA polyester is illustrated by the fact that for hydroxy-functional Hybrane®-type polymers, a 10% or more molar excess of DIPA (diisopropanolamine) or of an alternative polyol over anhydride must be used in order to avoid gelation at high conversion, whereas in an ideal A₂B-like case, a 1:1 stoichiometric ratio should be possible.

Therefore there is a serious need for hyperbranched polymers that combine the full advantages of the A₂B polycondensation concept (relatively narrow MMD, high Mn values obtainable without gelation) with the flexibility and versatility of the A₃+B₂ (or A₂a+Bb) concept.

### SUMMARY OF THE INVENTION

It has now been found that hyperbranched esteroxazoline polymers can be synthesized which are very close to those described above, with advantages in hyperbranched architecture compared to the Hybrane®-type hyperbranched polyesteramides. Esteroxazoline polymers are known in the art. In U.S. Pat. No. 4,504,602 esteroxazoline oligomers are prepared by reacting a monocarboxylic acid, an anhydride or dicarboxylic acid, a glycol, and a tris-hydroxyalkyl aminomethane. These ester-oxazoline polymers contain 4 to 20% oxazoline units in the molecule. In the examples mentioned, the oligomers described would have theoretical Pn values at maximum conversion of 3-5.8. These materials are not considered to be hyperbranched polyesteroxazolines under the definition used here. Other esteroxazoline polymers are disclosed in DE 1223155, which are oligomers with a Pn of 5 and again not considered to be hyperbranched polyesteroxazoline polymers.

It was found that a hyperbranched esteroxazoline polymer obtainable from a polymerization reaction of A-functional and one or more B-functional compounds, characterized in that the polymer comprises a polymer backbone having ester and oxazoline groups and having hydroxymethyl end groups, wherein the A-functional compound stands for a tris(hydroxymethyl)methanamine (trisA) and the B-functional compounds are selected from dicarboxylic acids and derivatives thereof which are capable of reacting as a dicarboxylic acid would, such as a cyclic anhydride; the backbone having a ratio of equivalents of oxazoline groups to equivalents of backbone ester groups of 1:2 to 2:1, and a number average degree of polymerization Pn greater than 6, satisfies the desired characteristics described above.

In this definition, the term backbone ester refers to both ester groups that are built into a polymer backbone and ester groups that are associated with Bb or B₂ (e.g., anhydride, diacid) units linking two Aₙ or Aₙa (a polyol or trisA) units (thereby excluding ester groups which are formed by a monofunctional capping unit).

### DETAILED DESCRIPTION OF THE INVENTION

The chemistry is based on a highly selective first step in which a primary amine reacts with one or more diacids or compounds capable of reacting as if one or more diacids were present, followed by a further condensation of hydroxy groups, under the parallel formation of stable oxazoline groups through ring closure. The oxazoline ring will not open to react with a carboxylic acid functionality on the trisA segment; by this method a trisA molecule behaves as a trifunctional building block in the polycondensation, despite the four active moieties originally present (OH and NH₂ groups) which are capable of reacting with a carboxylic acid group. It is shown that the oxazoline formation is a quantitative process, as shown by the amount of water separated, as well as the hydroxy number of the resin formed.

These hyperbranched esteroxazoline polymers offer a broad versatility in tuning the physical properties of the esteroxazoline polymer hyperbranched core through the choice of the anhydride (or dicarboxylic acid) and benefit from the special characteristics (e.g. adhesion promotion) of the stable basic oxazoline groups formed in the condensation process.

Compared to the DIPA-anhydride chemistry discussed above, the chemistry in the present system suffers less from side-reactions and randomization through reversibility: thus a real A₂B polycondensation product is approached much more closely than with the DIPA chemistry, as is illustrated by the fact that a 1:1 ratio of trisA and hexahydrophthalic anhydride can be condensed into a hydroxy-functional resin at high conversion without gelation, whereas the corresponding DIPA reaction requires a more than 10% molar excess of DIPA (or alternative polyol) to avoid gelation under similar conditions. Hence, in a preferred embodiment of the invention the trisA is reacted in a first step with one or more diacids, or reagents giving a comparable result, wherein the two reactants are used in a molar ratio from 0.9:1.0 to 1.1:1.0. Preferably, the molar excess of one of the reactants is less than 9%, more preferably less than 8%, even more preferably less than 7%, and most preferably less than 6%.

The molecular weight of the hyperbranched esteroxazoline polymers of this invention can be tuned through the stoichiometry of A-functional compounds to B-functional compounds, as is known in the art. For creating an excess of A-derived groups, excess of trisA can be used, but also other An polyols can be used, such as, e.g., trimethylolpropane, pentaerythritol, or their dimers, or their ethoxylated or propoxylated derivatives.

The polymer composition according to the invention generally is a composition comprising higher and lower hyperbranched oligo- and polymers which usually contain less than 50 wt. %, preferably less than 30 wt. %, of oligomers having a molecular weight smaller than 600. The molecular weight of the resin resulting from the condensation of A₂a and Bb building blocks which are used for the resin backbone (e.g. trisA with a cyclic anhydride, again with the trisA considered to be a trifunctional molecule in terms of polycondensation) can be described in terms of the ratio of number functional groups that can react complementarily (A+a)/(B+b) (further called A/B) of the polyfunctional (f=2 or more) building blocks forming the backbone of the resin. In our definition a resin is considered to be hyperbranched if the ratio A/B if less than 2. This value corresponds to the lower gelation limit for a conventional A₃+B₂ condensation in terms of Flory's original theoretical description. At 100% conversion of the B-functional compounds with the A-functional compounds for a conventional A₃+B₂ condensation with a 4:3 stoichiometry, corresponding to the Flory gelation limit mentioned above, the number average degree of polymerization Pn will be 7.

The hyperbranched polymer of this invention has a number average degree of polymerization Pn greater than 6, preferably greater than 7, more preferably greater than 10, and most preferably greater than 12.

The calculation of the Pn based on stoichiometry, neglecting cyclizations, is known in the art and is easily performed with commercially available computer programs. For instance, Pn is the quotient of the number of polyfunctional starting molecules and the difference between the number of starting molecules and the number of molecule-molecule bonds formed during the polymerization. The number of formed molecule-molecule bonds equals the maximum number of formed molecule-molecule bonds on the basis of complete conversion of the B-functional compound, multiplied by the conversion of the B-functionality. In the case of 4 moles of TrisA (functionality 3!) and 3 moles of anhydride (A/B=2) being reacted, 6 mole bonds are formed at complete conversion of the B-functional compound. Pn therefore is (4+3)/1=7. At 90% conversion of the B-functional compound Pn is (4+3)/(4+3−0.9×6)=4.4.

The ratio of oxazoline groups to backbone ester groups can vary with the A/B ratio targeted, and with the extent of incorporation of Aₙ-type polyols next to the trisA (A₂a) building blocks. This ratio should be less than 2, but higher than 0.5, preferably higher than 0.7, most preferably higher than 0.9.

Non-limiting examples of suitable diacids or compounds capable of reacting as a diacid which can be used in the reaction with TrisA are: cyclic anhydrides, such as phthalic anhydride, tetrahydrophthalic anhydride, naphthalenic dicarboxylic anhydride, hexahydrophthalic anhydride, 5-norbornene-2,3-dicarboxylic anhydride, norbornene-2,3-dicarboxylic anhydride, naphthalenic dicarboxylic anhydride, 2-dodecene-1-yl-succinic anhydride, maleic anhydride, itaconic anhydride, citraconic anhydride, (methyl)succinic anhydride, glutaric anhydride, 4-methylphthalic anhydride, 4-methylhexahydrophthalic anhydride, 4-methyltetrahydrophthalic anhydride, and the maleinized alkyl ester or alkylamide of an unsaturated fatty acid or rosin (abietic acid);

oligomeric anhydrides, such as compounds of the formula R—[C(O)OC(O)—R′—]ₙ—C(O)OC(O)—R″, with n being at least 1;

di-acidhalides, such as succinyl chloride; and

acid esters that can be transesterified, particularly the lower alkyl (preferably C1-C4) esters of diacids, such as the mono- and di-methyl ester of succinic acid.

In the hyperbranched polymers based on trisA according to the invention hydroxymethyl groups are present as an end group. In a preferred embodiment, the end groups are capped to change the functionality of the product. By doing so it is possible to make, for example, a more apolar hyperbranched polymer, or to equip it with a different reactive functionality. Capping can be performed with any compound that can react with a hydroxy group. Examples of suitable capping compounds include monofunctional carboxylic compounds, anhydrides, lower alkyl (preferably C1-C4) esters of carboxylic acids, acid halides, haloformates, lactones, hydroxyacids, carbonates, ureum, epoxides, oxetanes, isocyanates, reactive ethers, CS₂, and mercapto (carboxylic)acids. Also two or more of these capping agents can be used. In that case, the capping agents should not react with each other, or the different agents should be used in successive steps. If a di- or poly-functional capping agent is used, conditions are to be chosen such that just one of the functional groups reacts with a OH function of the trisA moiety.

If one or more monofunctional or difunctional carboxylic compounds are used as capping compounds, the reaction can take place simultaneously with the polycondensation of the backbone, simply by including the monofunctional compound with the other raw materials, or it can be done in a subsequent step after the backbone polycondensation has been completed. If a difunctional compound such as an anhydride is used as capping compound in order to convert hydroxy end groups to carboxylic end groups, the latter route should apply conditions that prevent transesterification or esterification of the carboxylic groups resulting upon ring opening of the anhydride. Note that, in this case, the anhydride used for capping is considered to be a monofunctional compound in terms of the definition of the oxazoline to backbone ester stoichiometry limits given above, even if the same anhydride was used for building the hyperbranched backbone.

Examples of suitable monofunctional carboxylic acids are, for example, saturated aliphatic (C1-C26) acids, unsaturated (C1-C20) acids, such as acrylic acid, and aromatic acids. Examples of suitable unsaturated acids are (meth)acrylic acid, crotonic acid, and fatty acids containing an unsaturated bond. Suitable saturated aliphatic acids are for example acetic acid, propionic acid, butyric acid, cyclo-hexanoic acid, 2-ethylhexanoic acid, polyether carboxylic acid, lauric acid, and stearic acid. Suitable aromatic acids are for example benzoic acid and tertiary butyl benzoic acid.

Suitable anhydrides that can be used for capping under mild conditions are, e.g., phthalic anhydride, tetrahydrophthalic anhydride, naphthalenic dicarboxylic anhydride, hexahydrophthalic anhydride, 5-norbornene-2,3-dicarboxylic anhydride, norbornene-2,3-dicarboxylic anhydride, naphthalenic dicarboxylic anhydride, 2-dodecene-1-yl-succinic anhydride, maleic anhydride, itaconic anhydride, citraconic anhydride, (methyl)succinic anhydride, glutaric anhydride, 4-methylphthalic anhydride, 4-methylhexahydrophthalic anhydride, 4-methyl-tetrahydrophthalic anhydride, and the maleinized alkyl ester or alkylamide of an unsaturated fatty acid or rosin (abietic acid).

Suitable lower alkyl esters of carboxylic acids are, for example, methyl esters. Suitable acid halides are acid chlorides. Suitable haloformates are chloroformates. Suitable lactones include caprolactones. An example of a suitable hydroxyacid is 12-hydroxy-stearic acid. Suitable carbonates include ethylene carbonate, propylene carbonate, and dimethyl carbonate. Suitable epoxides are ethylene oxide and propylene oxide. Suitable isocyanates include isophorone diisocyanate. Preferably, the diisocyanate used is made of a compound containing two or more isocyanate groups of different reactivity. Suitable reactive ethers include ethyl vinyl ether. An example of a preferred mercapto (carboxylic)acid is mercapto propionic acid.

Clearly the use of monofunctional carboxylic acid capping agents will result in end groups of the acid which are preferably a-polar (a dipole <OD). If an unsaturated mono-functional acid is used, such as acrylic acid, monomaleic acid, or unsaturated fatty acids, the end group will also be unsaturated. Difunctional carboxylic acids, or compounds capable of forming such compounds, can result in end groups with carboxylic acid functions. The use of haloformates and/or dicarbonates can result in the formation of end groups with carbonate functionality, which include, for example, carbonylbisimidazoles. The use of epoxides and lactones can result in the formation of end groups with another type of hydroxy functionality. The use of a diisocyanate results in an isocyanate-functional polymer. SH-functional end groups can be obtained through use of the mercaptoacids.

The polymers according to the invention can be obtained in a one-step procedure by reacting a cyclic anhydride (or a diacid) and TrisA, at a temperature between for example about 100° C. and about 300° C. to form the hyperbranched esteroxazoline polymer with water being removed through distillation. The reaction can take place with or without an auxiliary solvent. The removal of water through distillation can take place at a pressure higher than 1 bar, in a vacuum, or azeotropically. A subsequent step modifying the remaining functional groups can be incorporated into the procedure.

The hyperbranched esteroxazoline polymers can also be processed into aqueous emulsions and dispersions. Hydroxy-functional emulsions can be easily prepared, either as a cationic emulsion at low pH or as an anionic emulsion, after the hydroxy-functionality has been partly converted to e.g. carboxylic acid through e.g. a ring opening reaction with a cyclic anhydride.

The hyperbranched esteroxazoline polymers and modifications thereof can be used in resin compositions. These resin compositions will generally be used in powder-paint systems, in solvent based or water borne coating systems, radiation curable compositions, unsaturated resins for construction purposes, including dental applications, in ink compositions, toners, film formers for (glass) fibre sizings, adhesive compositions, hot melts, etc. The polymers can also be used as sizing agents for the paper industry, as additives in thermoplastic polymers, e.g. to improve the adhesion of coatings to PP and to improve the dyability of natural and synthetic fibres, and for making masks in etching technologies (e.g. for semi-conductors).

The invention will be elucidated with reference to the following, non-limiting examples.

### EXAMPLE 1

A reaction vessel equipped with a Dean-Stark trap was charged with 209 g of tris(hydroxymethyl)aminomethane (TrisA, 1.725 moles) and 231.3 g of hexahydrophthalic anhydride (HHPA) (1.5 moles, molar excess polyol 15%), and xylene as entraining agent. No catalyst was added. The temperature was raised to 150° C., and the water produced was removed through the Dean-Stark apparatus. The reaction was continued for 5 h, the temperature being slowly raised to 180° C., until no more water was liberated, and the acid value of the resin was 5 mg KOH/g. The amount of water collected was 55 ml (expected value for complete oxazoline-ester formation 58 ml). The Tg of the resin was 77-89° C. (DSC). SEC analysis in THF yields Mn 831, Mw 1,937 (polystyrene equivalents), dispersity 2.3. The theoretical Pn is 12.4.

### EXAMPLE 2

A reaction vessel equipped with a Dean-Stark trap was charged with 384.2 g of tris(hydroxymethyl)aminomethane (TrisA, 3.15 moles) and 463.1 g of hexahydrophthalic anhydride (HHPA) (3 moles, molar excess 5%), and 150 g of xylene as entraining agent. No catalyst was added. The temperature was raised to 150° C., and the water produced was removed through the Dean-Stark apparatus. The reaction was continued for 6 h, the temperature being slowly raised to 185° C., until no more water was liberated, and the acid value of the resin was 6.2 mg KOH/g. The amount of water collected was 112 ml, the OH-value 275 mg KOH/g (expected values for complete oxazoline-ester formation 111 ml and 267 mg KOH/g, respectively). The Tg of the resin was 63° C. (DSC). SEC analysis in THF yields Mn 1,046, Mw 3,534 (polystyrene equivalents), dispersity 3.4. The theoretical Pn is 26.6.

### EXAMPLE 3

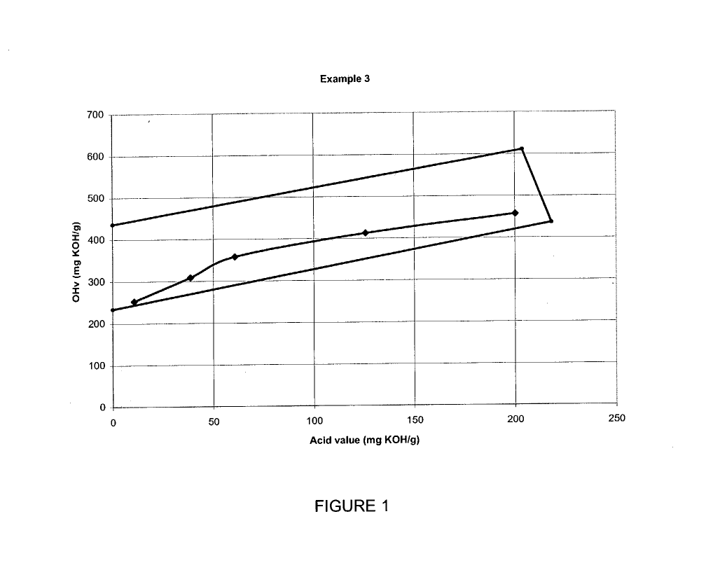

A reaction vessel equipped with a Dean-Stark trap was charged with 363.4 g of TrisA (3.0 moles) and 462.5 g of hexahydrophthalic anhydride (HHPA) (3.0 moles, molar ratio 1.0), and xylene as entraining agent. No catalyst was added. The temperature was slowly raised to 155° C., and the water produced was removed through the Dean-Stark apparatus. The reaction was stopped when 6 moles of water were collected, and no more water was released. The obtained resin had an acid value of 3.7 mg KOH/g, and a corresponding OH-value of 220 mg KOH/g (theory for complete oxazoline ester formation 234). SEC analysis in THF yields Mn 1,700, Mw 9,500 (polystyrene equivalents), dispersity 5.6. A graph of the OH value vs. the acid value of a trisA-HHPA resin upon polycondensation is added as FIG. 1. The upper line corresponds to a theoretical polycondensation without oxazoline formation; the lower line corresponds to a theoretical polycondensation with maximum oxazoline formation. It shows that the oxazoline formation occurs in the early stages of the condensation process. The theoretical Pn is 126.

Titration of the resin with perchloric acid indicates the presence of oxazoline weak base (comparing HCl and HClO₄ titration) functionalities. The “oxazoline number” determined this way (180 mg KOH/resin) was somewhat lower than theoretically expected (234 mg KOH/g) due to precipitation of the resin upon protonation during titration.

### COMPARATIVE EXAMPLE 1

A reaction vessel equipped with a Dean-Stark trap was charged with 439.5 g of di-isopropanolamine (DIPA, Aldrich, 3.3 moles) and 462.2 g of HHPA (3.0 moles, molar ratio 1.10), and xylene as entraining agent. No catalyst was added. The temperature was raised to 130° C., and the water produced was removed through the Dean-Stark apparatus. The temperature was slowly raised to 165° C. When the reaction was near completion (amount of water collected 54 ml), the reaction mixture was observed to gel. The reaction product was no longer fully soluble in THF.

Repeating this experiment with 294.5 g of DIPA and 308.3 g of HHPA (molar ratio 1.106) and condensing at temperatures up to 180° C. again led to gelation close to completion.

Another experiment, with a molar ratio of DIPA to HHPA of 1.05, turned into a gel at an earlier stage of the condensation.

### EXAMPLE 4

The polyesteroxazoline resin of Example 3 was dissolved in NMP (40.1 grams in 30 ml of NMP). 14.95 grams of HHPA were added, and the mixture was heated at 110° C. for 60 minutes. An acid number of 71 mg KOH/g was determined (expected value for selective anhydride hydroxyl reaction is 64 mgKOH/g). SEC analysis of the COOH functional resin indicated a (PS equivalent) Mn of 2,800, Mw 17,800. The resin was neutralized with dimethylaminoethanol (DMEA) and emulsified in water as concentrated NMP solution, to yield a stable emulsion with pH 7. Further addition of DMEA to pH 9 caused the emulsion to turn into a clear solution.

### EXAMPLE 5

A reaction vessel equipped with a Dean-Stark trap was charged with 403 g of TrisA (3.326 moles) and 518.9 g of HHPA (3.36 moles), 38.45 g of di-trimethylolpropane (diTMP, the condensation product of two trimethylolpropane molecules) (0.15 moles, molar excess polyol 3.5%), and xylene as entraining agent. No catalyst was added. The temperature was raised to 150° C., and the water produced was removed through the Dean-Stark apparatus. The reaction was continued for 5 h, the temperature being slowly raised to 180° C., until the acid value of the resin was 5.4 mg KOH/g. The amount of water collected was 114 ml (expected value for complete oxazoline-ester formation 120). SEC analysis in THF yields Mn 1,006, Mw 4,307 (polystyrene equivalents), dispersity 4.28. The theoretical Pn is 34.6.

Comparing the esteroxazoline polymers with the DIPA based polyesteramides, it is clear that the ideal A₂B stoichiometry of 1:1 can be approached more closely by the former system than the latter.

### EXAMPLE 6

A reaction vessel equipped with a Dean-Stark trap was charged with 363.4 g of TrisA (3.0 moles) and 471 g of HHPA (3.06 moles), 28.2 g of trimethylolpropane (TMP) (0.21 moles, molar excess polyol 5%), and xylene as entraining agent. 2.2 grams of Sn(II)octoate were added as catalyst. The temperature was slowly raised from 125 to 150° C., and the water produced was removed through the Dean-Stark apparatus. The reaction was continued for 8 h, until 105 ml water were isolated (theoretical: 108 ml for full oxazoline formation). The resulting resin had an acid value of 2.5 mg KOH/g., SEC values: Mn 1,500; Mw 8,600.

### EXAMPLE 7

A reaction vessel equipped with a Dean-Stark trap was charged with 242 g of TrisA (2.0 moles) and 296 g of phthalic anhydride (2.0 moles, molar ratio 1.0), 25.1 g of diTMP (0.1 moles), and xylene as entraining agent. No catalyst was added. The temperature was raised to 150° C., and the water produced was removed through the Dean-Stark apparatus. The reaction was continued for 5 h, the temperature being slowly raised to 190° C., until the acid value of the resin was 9.3 mg KOH/g (amount of water collected: 65 ml). The theoretical Pn is 22.4.

### EXAMPLE 8

A reaction vessel equipped with a Dean-Stark trap was charged with 242.3 g of TrisA (2.0 moles) and 471 g of dodecenylsuccinic anhydride (2.0 moles), 18.8 g of trimethylolpropane (TMP) (0.14 moles, molar excess polyol 7%), and xylene as entraining agent. 2.0 grams of Sn(II)octoate were added as catalyst. The temperature was slowly raised from 125 to 148° C., and the water produced was removed through the Dean-Stark apparatus. The reaction was continued for 8 h, until 67 ml water were isolated (theoretical: 72 ml). The resulting resin had an acid value of 4 mg KOH/g. SEC indicated a (PS equivalent) Mn of 1,650, Mw 3,100, polydispersity 1.88.

### EXAMPLE 9

A reaction vessel equipped with a Dean-Stark trap was charged with 424 g of TrisA (3.5 moles) and 350.3 g succinic anhydride (3.5 moles), 32.9 g of trimethylolpropane (TMP) (0.25 moles, molar excess polyol 7%), and xylene as entraining agent. 2.0 grams of Sn(II)octoate were added as catalyst. The temperature was slowly raised from 125 to 148° C., and the water produced was removed through the Dean-Stark apparatus. The reaction was continued for 4 h, until 116 ml water were isolated (theoretical: 126 ml). The resulting resin had an acid value of 9 mg KOH/g.

### EXAMPLE 10

A reaction vessel equipped with a Dean-Stark trap was charged with 259.5 g of TrisA, (2.14 moles) and 308.4 g of HHPA (2.0 moles, molar ratio 1.07), and xylene as entraining agent. No catalyst was added. The temperature was raised to 150° C., and the water produced was removed through the Dean-Stark apparatus. The reaction temperature was slowly raised to 180° C., until the acid value of the resin was 9.7 mg KOH/g. At this stage, 70 ml of water were collected. The theoretical Pn in this stage: is 18.3.

315 g of acetic anhydride were added and reacted at 120-130° C. for several hours, after which all volatile components were stripped in vacuo at 130° C. The acetylated resin has a SEC (THF, PS eq) Mn of 1,576 and a Mw of 5,380 g/mole.

### EXAMPLE 11

A reaction vessel equipped with a Dean-Stark trap was charged with 259.3 g of TrisA, (2.14 moles) and 308.3 g of HHPA (2.0 moles, molar ratio 1.07), and xylene as entraining agent. No catalyst was added. The temperature was raised to 150° C., and the water produced was removed through the Dean-Stark apparatus. The reaction was slowly raised to 180° C., until 68 ml of water were collected. At this stage, 261.3 g of benzoic acid were added, and the condensation was continued until an acid value of 9.7 mg KOH/g was obtained. The theoretical Pn is 18.3.

SEC analysis of this sample (THF) using viscosity detection (Viscotek) yields a Mark-Houwink coefficient of 0.27, which is indicative of the strongly branched character of the resin, and compares favourably to the values reported for the Hybrane®-type polyesteramides (Macromolecules, 34, 3552 (2001)), again indicating that the present system behaves more like a “real” A₂B condensation.

### EXAMPLE 12

A reaction vessel equipped with a Dean-Stark trap was charged with 254.4 g of TrisA, (2.1 moles) and 308.3 g of HHPA (2.0 moles, molar ratio 1.05), and xylene as entraining agent. No catalyst was added. The temperature was raised to 150° C., and the water produced was removed through the Dean-Stark apparatus. The reaction was slowly raised to 185° C., until the acid value of the resin was 9.3 mg KOH/g. At this stage, the Tg of the resin was 79° C. The theoretical Pn at this stage is 22.5.

605 g of sunflower fatty acid were added, and condensation was continued until no more water was liberated. The alkyd resin has a Mn of 2,393, a Mw 6,835, dispersity 2.86 (SEC, THF, PS equivalent).

### COMPARATIVE EXAMPLE 2

A reaction vessel equipped with a Dean-Stark trap was charged with 294.4 g of DIPA (2.2 moles) and 308.4 g of HHPA (2.0 moles, molar ratio 1.1). The temperature was raised to 130° C., and some xylene was added. 644.4 g of tall oil fatty acid were added, and the reaction was continued with the temperature gradually being raised to 170° C. The water produced was removed through the Dean-Stark apparatus. After 6 h the reaction was completed to yield an alkyd resin of 58% oil length. The resin was characterized by an acid value of 2.8 mg KOH/g, a Mn of 2,672, a Mw of 12,367, and a polydispersity of 4.63 (SEC, THF, PS eq).

### COMPARATIVE EXAMPLE 3

A reaction vessel equipped with a Dean-Stark trap was charged with 279.8 g of DIPA (2.1 moles) and 308.4 g of HHPA (2.0 moles, molar ratio 1.05). The temperature was raised to 130° C., and some xylene was added. 644.4 g of tall oil fatty acid were added, and the reaction was continued with the temperature gradually being raised to 170° C. The water produced was removed through the Dean-Stark apparatus. After 6 h the reaction was completed to yield an alkyd resin of 58.3% oil length. The resin was characterized by an acid value of 4.1 mg KOH/g, a Mn of 2,721, a Mw of 17,471, and a polydispersity of 6.4 (SEC. THF, PS eq).

The difference in polydispersity between the esteroxazoline polymers and the DIPA based polyesteramides (this time produced by an early stage capping procedure which is claimed to allow less imination side reaction (Macromolecules, 34, 3559 (2001)) again indicates the closer resemblance to A₂B statistics of the former system.

### EXAMPLE 13

The (OH-functional) reaction condensation product of TrisA and HHPA of Example 2 was diluted with NMP, and 1 molar equivalent (relative to the oxazoline moieties) of sulfuric acid. The mixture was mixed with water under high shear, to yield a stable emulsion.

1. A hyperbranched esteroxazoline polymer obtainable from a polymerization reaction of A-functional and one or more B-functional compounds, characterized in that the polymer comprises a polymer backbone having ester and oxazoline groups and having hydroxymethyl end groups, wherein the A-functional compound stands for tris(hydroxymethyl)methanamine and the B-functional compounds are selected from dicarboxylic acids and derivatives thereof; said backbone having a ratio of equivalents of oxazoline groups to equivalents of backbone ester groups of 1:2 to 2:1, and a number average degree of polymerization Pn greater than 6.

2. The hyperbranched esteroxazoline polymer according to claim 1 wherein the hydroxymethyl end groups are capped with a hydroxy-reactive compound.

3. The hyperbranched esteroxazoline polymer according to claim 1 wherein Pn is greater than 7.

4. The hyperbranched esteroxazoline polymer according to claim 3 wherein Pn is greater than 10.

5. The hyperbranched esteroxazoline polymer according to claim 3 wherein Pn is greater than 12.

6. A process for the preparation of the hyperbranched esteroxazoline polymer according to claim 1, comprising the steps of i) condensing tris(hydroxymethyl)methanamine through polycondensation with one or more dicarboxylic acids, or derivatives thereof; and ii) cyclizing the amide and hydroxy moieties to form a hyperbranched esteroxazoline polymer with a backbone having a ratio of equivalents of oxazoline groups to equivalents of backbone ester groups of 1:2 to 2:1, and a number average degree of polymerization Pn greater than 6.

7. The process according to claim 6 wherein the remaining hydroxy functions of the hyperbranched esteroxazoline polymer are capped.

8. The process according to claim 7 wherein the capping agent is present during the condensation step, without interfering in said condensation step.

9. An emulsion or dispersion of the hyperbranched esteroxazoline polymer according to claim 1 in an aqueous medium.

10. A binder composition comprising the hyperbranched esteroxazoline polymer according to claim 1.

11. The binder composition according to claim 10, wherein the binder composition forms at least a part of a powder-paint system, solvent based or water borne coating system, radiation curable composition, unsaturated resin composition, ink composition, toner, fiber sizing composition, adhesive composition, hot melt composition, thermoplastic polymer, stain or dye, paper-forming composition, or etching composition.

12. A coating, ink, or adhesive composition utilizing the binder composition according to claim 10.
